(19) United States
(12) Patent Application Publication
(10) Pub. No.: US 2023/0026383 A1
(43) Pub. Date: Jan. 26, 2023

(54) LIQUID DISCHARGE HEAD ATTACHMENT DEVICE, LIQUID DISCHARGE UNIT, AND LIQUID DISCHARGE APPARATUS

(71) Applicants: Teppei KIKUCHI, Kanagawa (JP); Ryoma NAKAMURA, Tokyo (JP); Yoshiyuki ISHIYAMA, Kanagawa (JP)

(72) Inventors: Teppei KIKUCHI, Kanagawa (JP); Ryoma NAKAMURA, Tokyo (JP); Yoshiyuki ISHIYAMA, Kanagawa (JP)

(21) Appl. No.: 17/854,010

(22) Filed: Jun. 30, 2022

(30) Foreign Application Priority Data
Jul. 20, 2021 (JP) 2021-119720

(51) Int. Cl. B41J 2/14

(52) U.S. Cl. CPC B41J 2/1433; B41J 2002/14362

(57) ABSTRACT

A liquid discharge head attachment device includes a liquid discharge head including a plurality of nozzles that discharges liquid. The liquid discharge head has a nozzle face mounting the nozzles and a side face being perpendicular to the nozzle face. An attachment member is attached with the liquid discharge head. A position adjuster contacts the side face of the liquid discharge head and adjusts a position of the liquid discharge head with respect to the attachment member. The position adjuster is disposed outboard from the nozzles of the liquid discharge head. The position adjuster overlaps the liquid discharge head in an orthogonal direction perpendicular to the nozzle face of the liquid discharge head in at least a part of the position adjuster.

### CROSS-REFERENCE TO RELATED APPLICATION

This patent application is based on and claims priority pursuant to 35 U.S.C. § 119(a) to Japanese Patent Application No. 2021-119720, filed on Jul. 20, 2021, in the Japan Patent Office, the entire disclosure of which is hereby incorporated by reference herein.

### BACKGROUND

### Technical Field

Exemplary aspects of the present disclosure relate to a liquid discharge head attachment device, a liquid discharge unit, and a liquid discharge apparatus.

### Discussion of the Background Art

Related-art liquid discharge apparatuses, such as copiers, facsimile machines, printers, and multifunction peripherals (MFP) having two or more of copying, printing, scanning, facsimile, plotter, and other functions, typically discharge liquid.

Such liquid discharge apparatuses include an image forming apparatus that discharges ink onto a sheet such as paper to form an image on the sheet by an inkjet method.

The image forming apparatus includes a liquid discharge head that discharges ink. The liquid discharge head is requested to be positioned precisely to form the image on the sheet properly.

### SUMMARY

This specification describes below an improved liquid discharge head attachment device. In one embodiment, the liquid discharge head attachment device includes a liquid discharge head including a plurality of nozzles that discharges liquid. The liquid discharge head has a nozzle face mounting the nozzles and a side face being perpendicular to the nozzle face. An attachment member is attached with the liquid discharge head. A position adjuster contacts the side face of the liquid discharge head and adjusts a position of the liquid discharge head with respect to the attachment member. The position adjuster is disposed outboard from the nozzles of the liquid discharge head. The position adjuster overlaps the liquid discharge head in an orthogonal direction perpendicular to the nozzle face of the liquid discharge head in at least a part of the position adjuster.

This specification further describes an improved liquid discharge unit. In one embodiment, the liquid discharge unit includes a liquid discharge head including a plurality of nozzles that discharges liquid. The liquid discharge head has a nozzle face mounting the nozzles and a side face being perpendicular to the nozzle face. An attachment member is attached with the liquid discharge head. A position adjuster contacts the side face of the liquid discharge head and adjusts a position of the liquid discharge head with respect to the attachment member. The position adjuster is disposed outboard from the nozzles of the liquid discharge head. The position adjuster overlaps the liquid discharge head in an orthogonal direction perpendicular to the nozzle face of the liquid discharge head in at least a part of the position adjuster.

This specification further describes an improved liquid discharge apparatus. In one embodiment, the liquid discharge apparatus includes a carriage and the liquid discharge unit described above that is mounted on the carriage.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a cross-sectional view of a liquid discharge head according to a first embodiment of the present disclosure, taken in a direction, that is, a longitudinal direction of a pressure chamber, perpendicular to a nozzle array direction of the liquid discharge head:

FIG. 2 is a cross-sectional view of the liquid discharge head depicted in FIG. 1, taken in the nozzle array direction;

FIG. 3 is a top view of a liquid discharge head attachment device attached with the liquid discharge head depicted in FIG. 1;

FIG. 4 is a bottom view of the liquid discharge head attachment device depicted in FIG. 3;

FIG. 5 is a side view of the liquid discharge head attachment device, seen in a direction A in FIG. 3;

FIG. 6 is a side view of the liquid discharge head attachment device, seen in a direction B in FIG. 3:

FIG. 7 is a diagram of a pressing arm incorporated in the liquid discharge head attachment device depicted in FIG. 3, illustrating pressure applied by the pressing arm:

FIG. 8 is a top view of the liquid discharge head attachment devices depicted in FIG. 3, illustrating a plurality of liquid discharge heads arranged in the nozzle array direction:

FIG. 9 is atop view of a first adjusting cam and a second adjusting cam incorporated in the liquid discharge head attachment device depicted in FIG. 3, illustrating variation of arrangement of the first adjusting cam and the second adjusting cam;

FIG. 10 is a top view of a position adjusting arm incorporated in the liquid discharge head attachment device depicted in FIG. 3, illustrating a displacement amount of the position adjusting arm at a point of effort and a point of application;

FIG. 11 is a top view of a liquid discharge head attachment device incorporating two pressure springs instead of the pressing arm depicted in FIG. 7;

FIG. 12 is a top view of a liquid discharge head attachment device incorporating a single pressure spring instead of the pressing arm depicted in FIG. 7;

FIG. 13 is a diagram of a U-shaped recess incorporated in the liquid discharge head depicted in FIG. 3;

FIG. 14 is a top view of a liquid discharge head attachment device incorporating two eccentric members instead of the first adjusting cam and the second adjusting cam depicted in FIG. 9;

FIG. 15 is a top view of a liquid discharge head attachment device incorporating two taper screws instead of the first adjusting cam and the second adjusting cam depicted in FIG. 9;

FIG. 16 is a diagram of the taper screw depicted in FIG. 15, illustrating a function of the taper screw;

FIG. 17 is an external perspective view of a liquid discharge head according to a second embodiment of the present disclosure;

FIG. 18 is a cross-sectional view of the liquid discharge head depicted in FIG. 17, taken in a direction perpendicular to a nozzle array direction of the liquid discharge head;

FIG. 19 is a schematic cross-sectional view of a liquid discharge apparatus as a first example that incorporates the liquid discharge head attachment device depicted in FIG. 3;

FIG. 20 is a plan view of a head unit incorporated in the liquid discharge apparatus depicted in FIG. 19;

FIG. 21 is a block diagram of a liquid recirculating apparatus incorporated in the liquid discharge apparatus depicted in FIG. 19;

FIG. 22 is a plan view of a main section of a liquid discharge apparatus as a second example that incorporates the liquid discharge head attachment device depicted in FIG. 3;

FIG. 23 is a side view of the main section of the liquid discharge apparatus depicted in FIG. 22, illustrating a liquid discharge unit as a first example incorporated in the liquid discharge apparatus;

FIG. 24 is a plan view of a main section of a liquid discharge unit as a second example installable in the liquid discharge apparatus depicted in FIG. 22:

FIG. 25 is a front view of a liquid discharge unit as a third example installable in the liquid discharge apparatus depicted in FIG. 22; and

FIG. 26 is a top view of a comparative liquid discharge head attachment device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”. “an”, and “the” are intended to include the plural forms as well, unless the context clearly indicates otherwise.

Referring to attached drawings, the following describes embodiments of the present disclosure.

In the drawings for explaining the embodiments of the present disclosure, identical reference numerals are assigned to elements such as members and parts that have an identical function or an identical shape as long as differentiation is possible and a description of those elements is omitted once the description is provided.

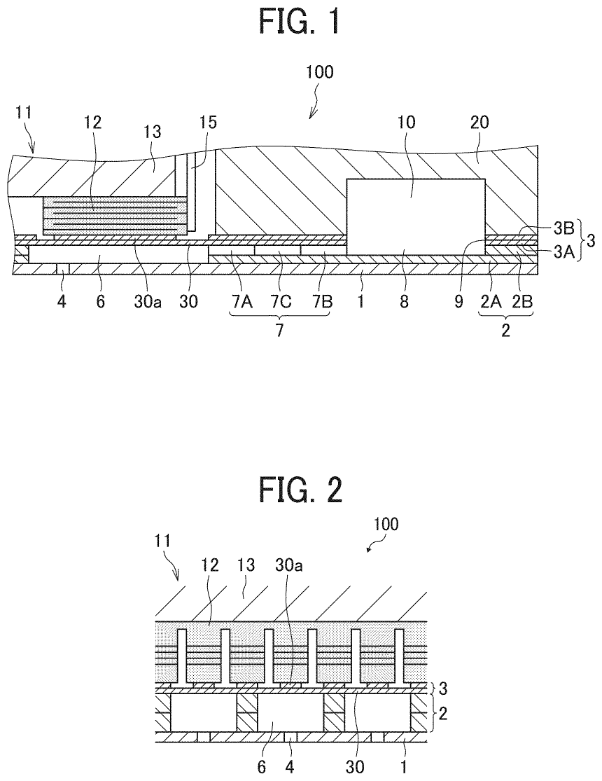

FIG. 1 is a cross-sectional view of a liquid discharge head 100 according to a first embodiment of the present disclosure, taken in a direction (e.g., a longitudinal direction of a pressure chamber) perpendicular to a nozzle array direction. FIG. 2 is a cross-sectional view of the liquid discharge head 100 taken in the nozzle array direction.

The liquid discharge head 100 according to this embodiment includes a nozzle plate 1, a channel substrate 2 serving as a separate pressure channel, and a vibrating plate member 3 serving as a wall, which are joined into a multilayer. The liquid discharge head 100 further includes a piezoelectric actuator 11 and a common channel 20. The piezoelectric actuator 11 displaces a vibrating portion 30 (e.g., a vibrating plate) of the vibrating plate member 3. The common channel 20 also serves as a frame of the liquid discharge head 100.

The nozzle plate 1 includes a plurality of nozzles 4 that discharges liquid.

The channel substrate 2 forms a plurality of pressure chambers 6, a separate supply channel 7, and an intermediate supply channel 8. The plurality of pressure chambers 6 communicates with the plurality of nozzles 4. The separate supply channel 7 serves as a separate pressure channel that communicates with each pressure chamber 6. The intermediate supply channel 8 serves as a liquid inlet that communicates with one or more separate supply channels 7 (e.g., a single separate supply channel 7 according to this embodiment).

The separate supply channel 7 includes two channel portions, that is, a first channel portion 7A and a second channel portion 7B, which have fluid resistances greater than a fluid resistance of the pressure chamber 6. The separate supply channel 7 further includes a third channel portion 7C that is interposed between the first channel portion 7A and the second channel portion 7B and has a fluid resistance smaller than the fluid resistances of the first channel portion 7A and the second channel portion 7B, respectively.

The channel substrate 2 is constructed of a plurality of plates 2A and 2B that is layered. Alternatively, the channel substrate 2 may have other construction.

The vibrating plate member 3 includes the plurality of vibrating portions 30 (e.g., the vibrating plates) that forms a wall of the pressure chamber 6 formed by the channel substrate 2 and is movable. According to this embodiment, the vibrating plate member 3 is constructed of two layers. Alternatively, the vibrating plate member 3 may have other construction. The vibrating plate member 3 includes a first layer 3A serving as a decreased thickness portion mounted on the channel substrate 2 and a second layer 3B serving as an increased thickness portion.

The first layer 3A serving as the decreased thickness portion includes the vibrating portion 30 that corresponds to or is disposed opposite the pressure chamber 6 and is deformable. The vibrating portion 30 includes a projection 30a serving as an increased thickness portion that is disposed in the second layer 3B and adjoins the piezoelectric actuator 11.

The piezoelectric actuator 11 is disposed opposite the pressure chamber 6 via the vibrating plate member 3. The piezoelectric actuator 11 includes an electromechanical transducer element serving as a driver (e.g., an actuator and a pressure generator) that deforms the vibrating portion 30 of the vibrating plate member 3.

The piezoelectric actuator 11 is produced as below. A piezoelectric member adjoining a base 13 is treated with grooving by half-cut dicing. A predetermined number of tubular piezoelectric elements 12 is arranged in the nozzle array direction with a predetermined gap therebetween into a comb teeth shape. The piezoelectric element 12 adjoins the projection 30a serving as the increased thickness portion of the vibrating portion of the vibrating plate member 3.

The piezoelectric element 12 is constructed of piezoelectric layers and internal electrodes that are layered reciprocally. The internal electrodes are drawn out to an end face and coupled with an external electrode (e.g., an end face electrode) that is coupled with a flexible wire 15.

The common channel 20 forms a common supply channel 10 that communicates with the plurality of pressure chambers 6. The common supply channel 10 communicates with the intermediate supply channel 8 serving as the liquid inlet through an opening 9 provided in the vibrating plate member 3. The common supply channel 10 communicates with the separate supply channel 7 through the intermediate supply channel 8.

In the liquid discharge head 100, for example, as a voltage applied to the piezoelectric element 12 decreases from a reference potential (e.g., a midpoint potential), the piezoelectric element 12 contracts and pulls the vibrating portion 30 of the vibrating plate member 3. The pressure chamber 6 expands and increases a volume thereof, causing liquid to enter the pressure chamber 6.

Thereafter, as the voltage applied to the piezoelectric element 12 increases, the piezoelectric element 12 expands in a laminating direction. The piezoelectric element 12 deforms the vibrating portion 30 of the vibrating plate member 3 toward the nozzle 4. The pressure chamber 6 contracts and decreases the volume thereof, pressing the liquid inside the pressure chamber 6 and discharging the liquid from the nozzle 4.

A description is provided of an attachment structure for attaching the liquid discharge head 100 (e.g., a liquid discharge head attachment device 40) and a position adjusting mechanism for adjusting a position of the liquid discharge head 100 according to embodiments of the present disclosure.

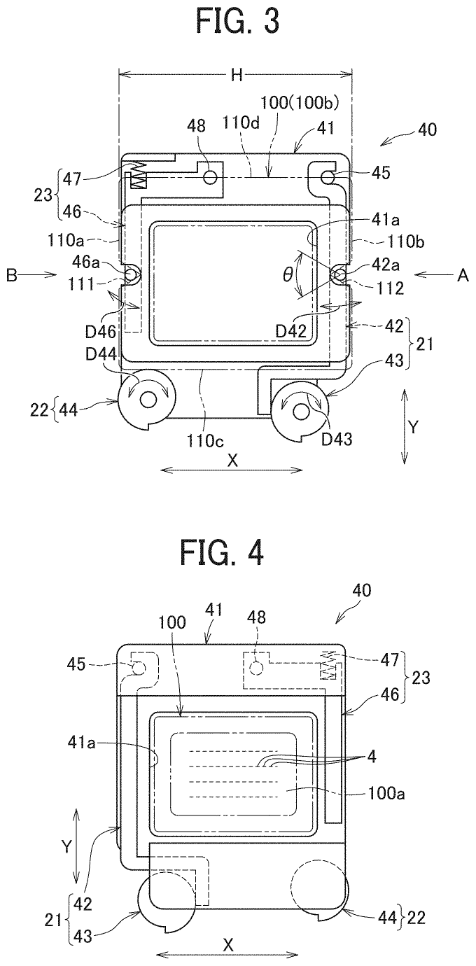

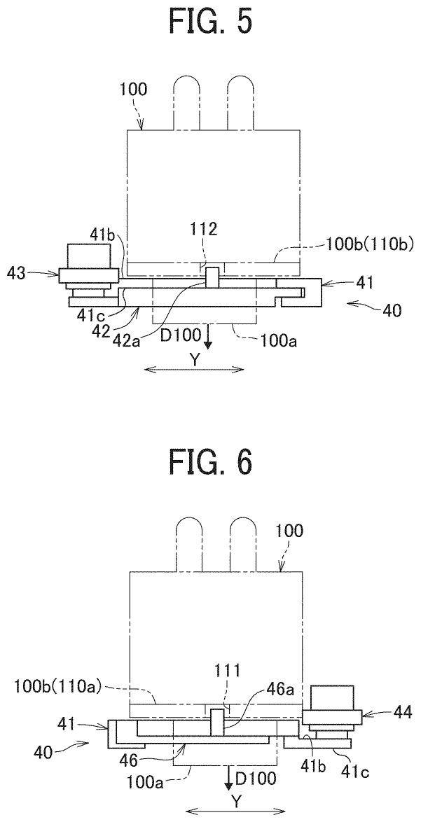

FIG. 3 is a top view of the liquid discharge head attachment device 40 according to an embodiment of the present disclosure. FIG. 4 is a bottom view of the liquid discharge head attachment device 40. FIG. 5 is a side view of the liquid discharge head attachment device 40, seen in a direction A in FIG. 3. FIG. 6 is a side view of the liquid discharge head attachment device 40, seen in a direction B in FIG. 3.

As illustrated in FIGS. 3 to 6, the liquid discharge head attachment device 40 (e.g., a liquid discharge head attachment structure) according to this embodiment includes an attachment plate 41 serving as an attachment member attached with the liquid discharge head 100. The attachment plate 41 is a frame provided with an insertion hole 41a on a center of the attachment plate 41. The insertion hole 41a is substantially rectangular.

The liquid discharge head 100 is inserted into the insertion hole 41a of the attachment plate 41 and attached to the attachment plate 41. For example, the liquid discharge head 100 is inserted into the attachment plate 41 such that a nozzle face 100a (e.g., a face of a nozzle plate) of the liquid discharge head 100 passes through the insertion hole 41a of the attachment plate 41. As a lower face of a flange 100b of the liquid discharge head 100 comes into contact with an upper face of the attachment plate 41, the liquid discharge head 100 is placed on and held by the attachment plate 41.

In order to adjust the position of the liquid discharge head 100, the insertion hole 41a is greater than an inserted portion of the liquid discharge head 100, which is inserted into the insertion hole 41a. For example, as described above, in a state in which the liquid discharge head 100 is inserted into the attachment plate 41 and held on the attachment plate 41, the liquid discharge head 100 is movable with respect to the attachment plate 41 along a parallel face parallel to the planar, nozzle face 100a. Hence, the liquid discharge head attachment device 40 according to this embodiment includes a mechanism for adjusting and determining the position of the liquid discharge head 100 with respect to the attachment plate 41.

For example, according to this embodiment, as the mechanism for adjusting and determining the position of the liquid discharge head 100, the attachment plate 41 mounts a first position adjuster 21, a second position adjuster 22, and a presser 23. The first position adjuster 21 adjusts and determines the position of the liquid discharge head 100 in a nozzle array direction X mainly. The second position adjuster 22 adjusts and determines the position of the liquid discharge head 100 in a rotation direction (e.g., a rotation direction θ depicted in FIG. 3) on the parallel face parallel to the nozzle face 100a mainly. The presser 23 contacts and presses the liquid discharge head 100. The nozzle array direction X defines a direction in which the plurality of nozzles 4 depicted in FIG. 4 is arranged linearly on the nozzle face 100a.

The first position adjuster 21 includes a position adjusting arm 42 and a first adjusting cam 43. The position adjusting arm 42 includes one end and another end in a longitudinal direction thereof. One end of the position adjusting arm 42 serves as a fulcrum. Another end of the position adjusting arm 42 pivots about the fulcrum. The first adjusting cam 43 serves as an arm position adjusting member that changes a position of the position adjusting arm 42 in a pivot direction D42 thereof. As illustrated in FIG. 3, the position adjusting arm 42 is attached to a support shaft 45 mounted on the attachment plate 41 at one end of the position adjusting arm 42, which is outboard from a center of the position adjusting arm 42 in the longitudinal direction thereof. As the position adjusting arm 42 pivots about the support shaft 45 serving as the fulcrum in the pivot direction D42, the position adjusting arm 42 pivots on the parallel face parallel to the nozzle face 100a.

The first adjusting cam 43 contacts another end of the position adjusting arm 42, which is disposed opposite one end of the position adjusting arm 42, which is supported by the support shaft 45, via the center of the position adjusting arm 42 in the longitudinal direction thereof. A distance (e.g., a radius) from a center of rotation to an outer circumferential face (e.g., a cam face) of the first adjusting cam 43 changes in a rotation direction D43 of the first adjusting cam 43. The outer circumferential face of the first adjusting cam 43 contacts the position adjusting arm 42.

The second position adjuster 22 includes a second adjusting cam 44. A distance (e.g., a radius) from a center of rotation to an outer circumferential face (e.g., a cam face) of the second adjusting cam 44 changes in a rotation direction D44 of the second adjusting cam 44. The outer circumferential face of the second adjusting cam 44 contacts the liquid discharge head 100 directly.

The presser 23 includes a pressing arm 46 and a pressure spring 47. The pressing arm 46 includes one end and another end in a longitudinal direction thereof. One end of the pressing arm 46 serves as a fulcrum. Another end of the pressing arm 46 pivots about the fulcrum in a pivot direction D46. The pressure spring 47 presses and biases the pressing arm 46. The pressing arm 46 is supported by a support shaft 48 serving as a fulcrum mounted on the attachment plate 41. The pressing arm 46 pivots about the support shaft 48 on the parallel face parallel to the nozzle face 100a. As the pressure spring 47 biases the pressing arm 46, the pressing arm 46 presses the liquid discharge head 100. Thus, the liquid discharge head 100 pressed by the pressing arm 46 comes into contact with both the position adjusting arm 42 and the second adjusting cam 44.

For example, the flange 100b of the liquid discharge head 100 is constructed of four side faces, that is, side faces 110a, 110b, 110c, and 110d that intersect or are perpendicular to the nozzle face 100a. As the pressing arm 46 comes into contact with the side face 110a, that is, a left side face in FIG. 3, the pressing arm 46 presses the liquid discharge head 100. According to this embodiment, a recess 111 that is V-shaped is disposed on the left side face 110a of the flange 100b. The pressing arm 46 includes a projection 46a that contacts the recess 111.

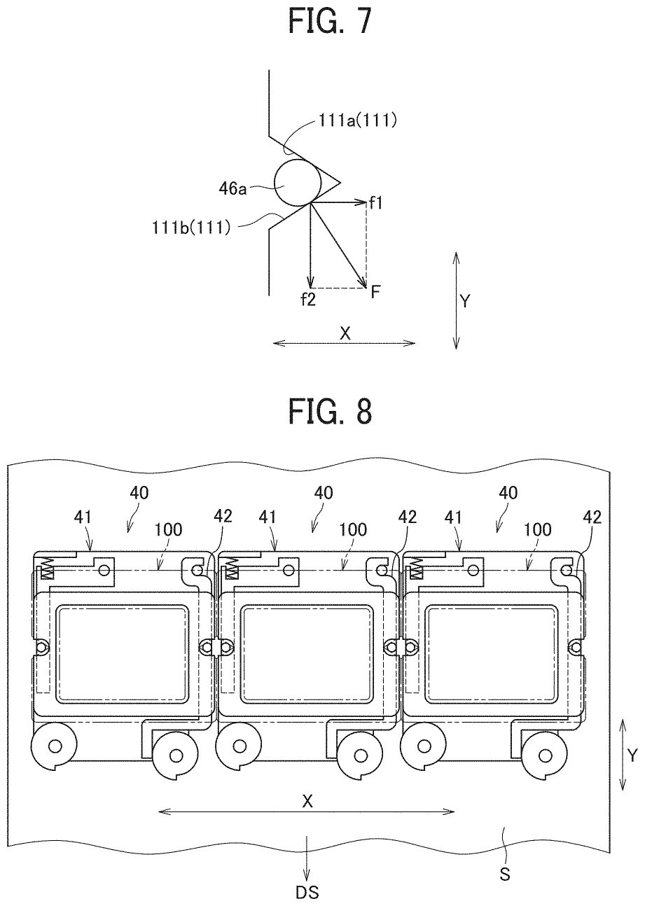

As illustrated in FIG. 7, as the projection 46a moves along a pivot orbit of the pressing arm 46, the projection 46a presses a slope 111b. The V-shaped recess 111 is constructed of two slopes, that is, a slope 111a and the slope 111b disposed below the slope 111a in FIG. 7. The pressing arm 46 generates a pressing force F that is divided into a component force f1 directed in the nozzle array direction X and a component force f2 directed in an orthogonal direction Y perpendicular to the nozzle array direction X through the lower slope 111b. Thus, the pressing arm 46 presses the liquid discharge head 100 in the nozzle array direction X and the orthogonal direction Y perpendicular to the nozzle array direction X with the component forces f1 and f2.

As the pressing arm 46 presses the liquid discharge head 100 in the nozzle array direction X, the side face 110b, that is, the right side face in FIG. 3, comes into contact with a projection 42a of the position adjusting arm 42. According to this embodiment, a recess 112 that is V-shaped is disposed on the right side face 110b. The recess 112 contacts the projection 42a of the position adjusting arm 42. As the recess 112 contacts the projection 42a, the liquid discharge head 100 presses the position adjusting arm 42 and pivots the position adjusting arm 42 in the pivot direction D42. However, the position adjusting arm 42 contacts the first adjusting cam 43 at one end of the position adjusting arm 42, which is opposite to another end supported by the support shaft 45 serving as the fulcrum. Thus, the first adjusting cam 43 restricts pivoting of the position adjusting arm 42. Accordingly, motion of the liquid discharge head 100 in the nozzle array direction X is also restricted.

The pressing arm 46 presses the liquid discharge head 100 also in the orthogonal direction Y perpendicular to the nozzle array direction X. Hence, although the second adjusting cam 44 presses the side face 110c, that is, a lower side face in FIG. 3, of the liquid discharge head 100, contact of the liquid discharge head 100 with the second adjusting cam 44 restricts motion of the liquid discharge head 100 in the orthogonal direction Y perpendicular to the nozzle array direction X. Accordingly, a position (e.g., an orientation) of the liquid discharge head 100 in the rotation direction θ in which the position adjusting arm 42 pivots about the projection 42a is determined.

As described above, as the liquid discharge head 100 is positioned in the nozzle array direction X and the rotation direction θ, the liquid discharge head 100 is positioned with respect to the attachment plate 41.

Parts constructing the liquid discharge head 100, the attachment plate 41, and the like may suffer from dimensional tolerance during manufacturing processes. Hence, when the liquid discharge head 100 is attached to the attachment plate 41, the liquid discharge head 100 may shift from a predetermined position. If the liquid discharge head 100 shifts from the predetermined position, the liquid discharge head 100 may not discharge liquid precisely. Hence, the position of the liquid discharge head 100 is requested to be adjusted with respect to the attachment plate 41. To address this circumstance, according to this embodiment, the position of the liquid discharge head 100 is adjusted as described below. The following describes a method for adjusting the position of the liquid discharge head 100 according to this embodiment.

In order to adjust the position of the liquid discharge head 100 in the nozzle array direction X, the first adjusting cam 43 rotates. As the first adjusting cam 43 rotates, the outer circumferential face (e.g., the cam face) of the first adjusting cam 43 moves the position adjusting arm 42. For example, if the first adjusting cam 43 rotates such that the distance (e.g., the radius) from the center of rotation of the first adjusting cam 43 to a contact portion on the outer circumferential face of the first adjusting cam 43, which contacts the position adjusting arm 42, increases, the first adjusting cam 43 presses and moves the position adjusting arm 42 leftward in FIG. 3. Accordingly, the projection 42a of the position adjusting arm 42 presses the liquid discharge head 100, moving the liquid discharge head 100 also leftward in FIG. 3. Conversely, if the first adjusting cam 43 rotates such that the distance (e.g., the radius) from the center of rotation of the first adjusting cam 43 to the contact portion on the outer circumferential face of the first adjusting cam 43, which contacts the position adjusting arm 42, decreases, the pressing arm 46 presses and moves the liquid discharge head 100 rightward in FIG. 3. Thus, as the first adjusting cam 43 rotates in one direction or an opposite direction thereof, the position of the liquid discharge head 100 is adjusted in the nozzle array direction X.

In order to adjust the position of the liquid discharge head 100 in the rotation direction θ, the second adjusting cam 44 rotates in one direction or an opposite direction thereof. As the second adjusting cam 44 rotates, the outer circumferential face (e.g., the cam face) of the second adjusting cam 44 presses and moves the liquid discharge head 100 directly. For example, if the second adjusting cam 44 rotates such that the distance (e.g., the radius) from the center of rotation of the second adjusting cam 44 to a contact portion on the outer circumferential face of the second adjusting cam 44, which contacts the side face 110c of the liquid discharge head 100, increases, the second adjusting cam 44 presses and moves the liquid discharge head 100 upward in FIG. 3. The orientation of the liquid discharge head 100 changes clockwise in FIG. 3 about the projection 42a of the position adjusting arm 42. Conversely, if the second adjusting cam 44 rotates such that the distance (e.g., the radius) from the center of rotation of the second adjusting cam 44 to the contact portion on the outer circumferential face of the second adjusting cam 44, which contacts the side face 110c of the liquid discharge head 100, decreases, the pressing arm 46 presses and moves the liquid discharge head 100 downward in FIG. 3. The orientation of the liquid discharge head 100 changes counterclockwise in FIG. 3 about the projection 42a of the position adjusting arm 42. Thus, as the second adjusting cam 44 rotates in one direction or the opposite direction thereof, the position of the liquid discharge head 100 is adjusted in the rotation direction θ on the parallel face being parallel to the nozzle face 100a of the liquid discharge head 100.

After the position of the liquid discharge head 100 is adjusted as described above, in order to determine whether or not the position of the liquid discharge head 100 is appropriate, the liquid discharge head 100 is installed into a target apparatus and a liquid discharge position onto which the liquid discharge head 100 discharges liquid is checked. If the liquid discharge position is not appropriate, the first adjusting cam 43 or the second adjusting cam 44 rotates again to adjust the position of the liquid discharge head 100 and the liquid discharge position is checked. Conversely, if the position of the liquid discharge head 100 is determined, the first adjusting cam 43 and the second adjusting cam 44 are secured by fastening with screws or the like, prohibiting rotation of the first adjusting cam 43 and the second adjusting cam 44. Thus, adjustment of the position of the liquid discharge head 100 is completed.

In adjustment of the position of the liquid discharge head 100 described above, the position of the liquid discharge head 100 is not particularly adjusted in the orthogonal direction Y perpendicular to the nozzle array direction X. For example, as illustrated in FIG. 8, if the liquid discharge heads 100 are arranged in the nozzle array direction X perpendicular to a sheet conveyance direction DS in which a sheet S onto which the liquid discharge heads 100 discharge liquid is conveyed, the position of each of the liquid discharge heads 100 may not be adjusted in the orthogonal direction Y perpendicular to the nozzle array direction X. In this case, a liquid discharge time when each of the liquid discharge heads 100 discharges liquid is adjusted with respect to a sheet conveyance time when the sheet S is conveyed, attaining an advantage equivalent to an advantage attained when the position of each of the liquid discharge heads 100 is adjusted in the orthogonal direction Y perpendicular to the nozzle array direction X. Hence, as the position of each of the liquid discharge heads 100 is adjusted in the nozzle array direction X and the rotation direction θ, shifting of the liquid discharge position is eliminated. As illustrated in FIG. 3, the projection 42a of the position adjusting arm 42 is situated in the recess 112 disposed on the side face 110b of the liquid discharge head 100. Alternatively, the projection 42a may contact the side face 110b (e.g., a plane) not provided with the recess 112. In this case, as the second adjusting cam 44 rotates, the position of the liquid discharge head 10 may be adjusted in the orthogonal direction Y perpendicular to the nozzle array direction X.

A description is provided of a construction of an inkjet recording apparatus as a comparative liquid discharge apparatus.

The comparative liquid discharge apparatus includes a liquid discharge head and a cam that contacts a side face of the liquid discharge head. As the cam rotates, a position of the liquid discharge head is adjusted.

However, in the comparative liquid discharge apparatus, the cam serving as a position adjuster is disposed outboard from the side face of the liquid discharge head, that is, disposed outside a liquid discharge head region. Accordingly, an extra space may be needed for installation of the cam, prohibiting saving space.

Referring to FIG. 26, a description is provided of a construction of a comparative liquid discharge head attachment device 40C that is different from the liquid discharge head attachment device 40 according to the embodiment of the present disclosure.

As illustrated in FIG. 26, the comparative liquid discharge head attachment device 40C includes two adjusting cams, that is, a first adjusting cam 81 and a second adjusting cam 82, serving as position adjusters that adjust a position of a liquid discharge head 200. One of the two adjusting cams, that is, the first adjusting cam 81, adjusts the position of the liquid discharge head 200 in the nozzle array direction X. Another one of the two adjusting cams, that is, the second adjusting cam 82, adjusts the position of the liquid discharge head 200 in the rotation direction θ on a parallel face parallel to a nozzle face (e.g., a face of a nozzle plate) of the liquid discharge head 200. The first adjusting cam 81 contacts a side face 210b of the liquid discharge head 200, which extends in the orthogonal direction Y perpendicular to the nozzle array direction X. The second adjusting cam 82 contacts aside face 210c of the liquid discharge head 200, which extends in the nozzle array direction X. The comparative liquid discharge head attachment device 40C further includes two pressure springs 83 and 84 that press and bias the liquid discharge head 200 against the first adjusting cam 81 and the second adjusting cam 82, respectively.

With the construction of the comparative liquid discharge head attachment device 40C described above, as the first adjusting cam 81 rotates, the position of the liquid discharge head 200 is adjusted in the nozzle array direction X. As the second adjusting cam 82 rotates, the position of the liquid discharge head 200 is adjusted in the rotation direction θ. However, in the comparative liquid discharge head attachment device 40C, the first adjusting cam 81 and the second adjusting cam 82 are entirely disposed outboard from the side faces 210b and 210c of the liquid discharge head 200, which contact the first adjusting cam 81 and the second adjusting cam 82, respectively. That is, the first adjusting cam 81 and the second adjusting cam 82 are entirely disposed outside a liquid discharge head region. Hence, each of the first adjusting cam 81 and the second adjusting cam 82 installed in the comparative liquid discharge head attachment device 40C occupies an extra space increased by a size of each of the first adjusting cam 81 and the second adjusting cam 82.

Conversely, according to the embodiment of the present disclosure, as illustrated in FIG. 3, when the liquid discharge head attachment device 40 is seen in a direction perpendicular to the nozzle face 100a, the position adjusting arm 42 serving as a position adjuster overlaps the liquid discharge head 100. That is, unlike the comparative liquid discharge head attachment device 40C having a configuration in which the first adjusting cam 81 and the second adjusting cam 82 serving as the position adjusters are entirely disposed outboard from the side faces 210b and 210c of the liquid discharge head 200, respectively, the liquid discharge head attachment device 40 according to the embodiment of the present disclosure has a configuration in which at least a part of the position adjusting arm 42 serving as the position adjuster is disposed inboard from the side face 110b of the liquid discharge head 100, thus saving space.

Additionally, according to this embodiment, an entirety of each of the position adjusting arm 42 and the first adjusting cam 43, a part of the second adjusting cam 44, and an entirety of each of the pressing arm 46 and the pressure spring 47 are disposed inboard from the pair of side faces 110a and 110b, that is perpendicular to the nozzle array direction X, and are disposed within a region H (e.g., a span) in the nozzle array direction X. Hence, the liquid discharge head attachment device 40 according to this embodiment saves space in the nozzle array direction X advantageously.

As factors that save space in the nozzle array direction X as described above, the following describes configurations of the liquid discharge head attachment device 40 according to this embodiment.

As a first factor, the flange 100b of the liquid discharge head 100 is provided with the recess 112 that contacts the projection 42a of the position adjusting arm 42 as illustrated in FIG. 3. Thus, according to this embodiment, since the projection 42a of the position adjusting arm 42 contacts the recess 112 disposed in the flange 10b, compared to a configuration in which the projection 42a contacts the side face 110b that is planar and is not provided with the recess 112, the position adjusting arm 42 protrudes outboard beyond the side face 110b with a decreased protruding amount, saving space.

As a second factor, the elongate, position adjusting arm 42 is used as the position adjuster. For example, if a shape of the position adjusting arm 42 changes, the first adjusting cam 43 that moves the position adjusting arm 42 is disposed arbitrarily. Hence, the first adjusting cam 43 is disposed at a position that is advantageous to save space. According to this embodiment, as illustrated in FIG. 3, the first adjusting cam 43 is disposed below the liquid discharge head 100 in FIG. 3. The first adjusting cam 43 and the second adjusting cam 44 are disposed together in an identical side defined by the liquid discharge head 100. That is, the first adjusting cam 43 and the second adjusting cam 44 are disposed below the liquid discharge head 100 in FIG. 3. Thus, the liquid discharge head attachment device 40 saves space in the nozzle array direction X.

With a configuration that saves space advantageously in the nozzle array direction X like this embodiment, as illustrated in FIG. 8, if the plurality of liquid discharge heads 100 is arranged, the liquid discharge heads 100 are preferably arranged in the nozzle array direction X. Thus, the liquid discharge head attachment device 40 saves space in the nozzle array direction X more advantageously. With the configuration in which the plurality of liquid discharge heads 100 is arranged, the single attachment plate 41 that mounts the first position adjuster 21, the second position adjuster 22, and the presser 23 is attached with the single liquid discharge head 100. Accordingly, even in a situation in which a number of the liquid discharge heads 100 increases, for example, the liquid discharge head attachment device 40 copes with the situation readily. However, the technology of the present disclosure is not limited to the configuration described above. For example, the plurality of liquid discharge heads 100 may be attached to the single attachment plate 41 collectively.

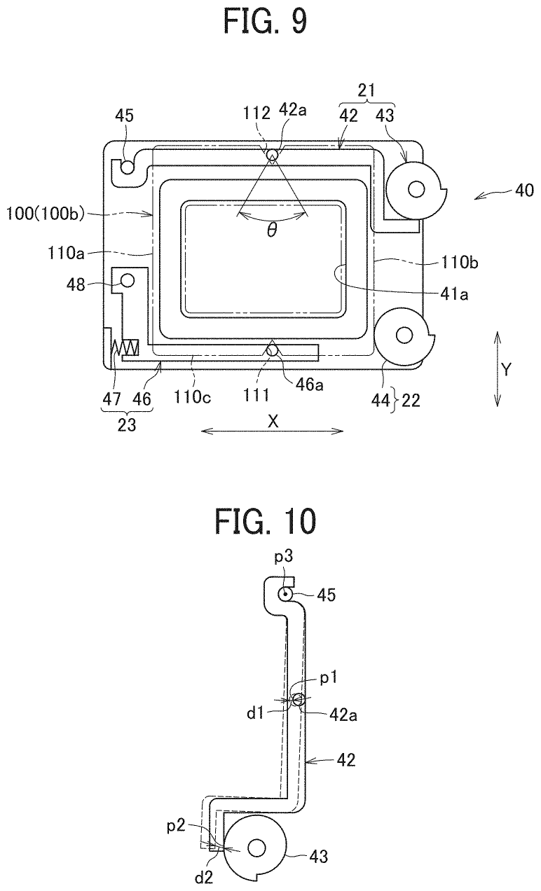

As illustrated in FIG. 3, the first adjusting cam 43 and the second adjusting cam 44 are disposed below the liquid discharge head 100 collectively. Alternatively, as illustrated in FIG. 9, the first adjusting cam 43 and the second adjusting cam 44 may be disposed on the right of the liquid discharge head 100 collectively. For example, as illustrated in FIG. 3, the first adjusting cam 43 and the second adjusting cam 44 are disposed opposite one of the side faces 110c and 110d of the liquid discharge head 100, that is, a pair of side faces, which extends in the nozzle array direction X. Alternatively, as illustrated in FIG. 9, the first adjusting cam 43 and the second adjusting cam 44 may be disposed opposite one of the side faces 110a and 110b of the liquid discharge head 100, that is, a pair of side faces, which intersects or is perpendicular to the nozzle array direction X.

As illustrated in FIG. 3, according to this embodiment, a part of each of the position adjusting arm 42 and the pressing arm 46 protrudes outward (e.g., downward or upward in FIG. 3) beyond the side faces 110c and 110d of the liquid discharge head 100, which extend in the nozzle array direction X, respectively. Even if a part of each of the position adjusting arm 42 and the pressing arm 46 protrudes outward beyond the side faces 110c and 110d of the liquid discharge head 100, respectively, compared to a configuration in which the entirety of each of the position adjusting arm 42 and the pressing arm 46 protrudes outward beyond the side faces 110c and 110d of the liquid discharge head 100, respectively, the liquid discharge head attachment device 40 saves space. In order to save space effectively, the position adjusting arm 42 and the pressing arm 46 preferably protrude outward beyond the side faces 110c and 110d, respectively, with a protruding amount not greater than 1 mm. The entirety of each of the position adjusting arm 42 and the pressing arm 46 preferably overlaps the liquid discharge head 100.

The liquid discharge head attachment device 40 according to this embodiment also improves adjustment of the position of the liquid discharge head 100 as described below in addition to saving space as described above. The liquid discharge head attachment device 40 according to this embodiment uses the position adjusting arm 42 as the position adjuster, adjusting the position of the liquid discharge head 100 finely and improving adjustment of the position of the liquid discharge head 100. For example, according to this embodiment, as illustrated in FIG. 10, a contact portion (e.g., a point of application p1) of the position adjusting arm 42, which contacts the side face 110b of the liquid discharge head 100, is closer to a fulcrum p3 (e.g., the support shaft 45) of the position adjusting arm 42 than a contact portion (e.g., a point of effort p2) of the first adjusting cam 43, which contacts the position adjusting arm 42, is. Hence, a displacement amount d1 of the point of application p1 when the first adjusting cam 43 rotates is smaller than a displacement amount d2 of the point of effort p2 (d1<d2). Conversely, as illustrated in FIG. 26, in the comparative liquid discharge head attachment device 40C, the first adjusting cam 81 contacts the liquid discharge head 200 directly to adjust the position of the liquid discharge head 200. Hence, a displacement amount with which an outer circumferential face (e.g., a cam face) of the first adjusting cam 81 moves in a radial direction thereof as the first adjusting cam 81 rotates corresponds to a moving amount of the liquid discharge head 200 directly. Conversely, according to this embodiment, the position adjusting arm 42 converts a displacement amount of the first adjusting cam 43 in a radial direction thereof into a decreased displacement amount that is applied to the liquid discharge head 100. Accordingly, compared to the comparative liquid discharge head attachment device 40C, the liquid discharge head attachment device 40 adjusts the position of the liquid discharge head 100 finely with an adjustment amount that varies every 10 μm, for example, improving accuracy in adjustment of the position of the liquid discharge head 100.

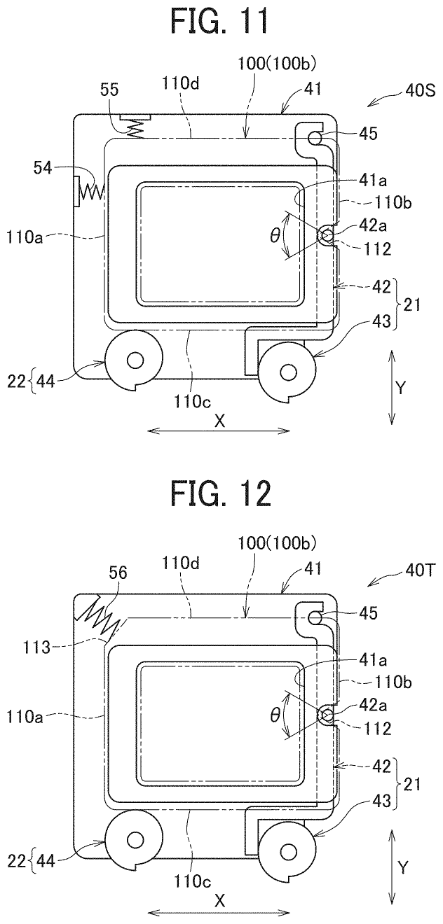

Additionally, according to this embodiment, as the presser 23 presses the slope 111b of the V-shaped recess 111 depicted in FIG. 7 disposed on the side face 110a of the liquid discharge head 100, the single presser 23 applies pressure in two directions, that is, the nozzle array direction X and the orthogonal direction Y perpendicular to the nozzle array direction X. For example, as illustrated in FIG. 11, a liquid discharge head attachment device 40S includes two pressure springs 54 and 55 serving as pressers that apply pressure in the nozzle array direction X and the orthogonal direction Y perpendicular to the nozzle array direction X, respectively. Hence, the liquid discharge head attachment device 40 depicted in FIG. 3 saves space more effectively compared to the liquid discharge head attachment device 40S depicted in FIG. 11. The technology of the present disclosure does not eliminate the liquid discharge head attachment device 40S incorporating the two pressure springs 54 and 55. If enough installation space is available, the liquid discharge head attachment device 40S depicted in FIG. 11 may be employed.

As illustrated in FIG. 12, a liquid discharge head attachment device 40T includes a single pressure spring 56 that applies pressure in both the nozzle array direction X and the orthogonal direction Y perpendicular to the nozzle array direction X. The liquid discharge head attachment device 40T further includes a slope 113 at a corner abutted on or defined by the side faces 110a and 110d of the liquid discharge head 100. The side face 110a is perpendicular to the side face 10d. As the pressure spring 56 biases or presses the slope 113, the pressure spring 56 applies pressure to the liquid discharge head 100 through the slope 113 in both the nozzle array direction X and the orthogonal direction Y perpendicular to the nozzle array direction X.

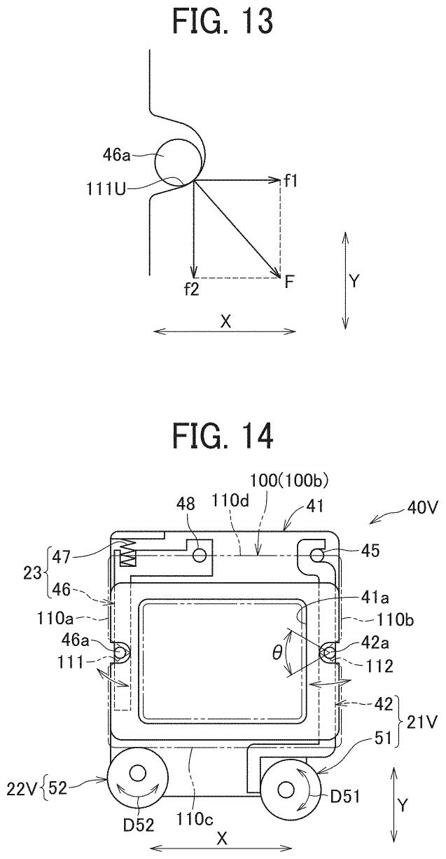

Each of the slope 111b depicted in FIG. 7 pressed by the pressing arm 46 depicted in FIG. 3 and the slope 113 pressed by the pressure spring 56 depicted in FIG. 12 is not limited to a plane illustrated in FIGS. 7 and 12 as long as each of the slopes 111b and 113 is inclined with respect to the nozzle array direction X. For example, each of the slopes 111b and 113 may be replaced by a recess 111U that is curved or U-shaped as illustrated in FIG. 13.

The position adjusting arm 42 and the pressing arm 46 do not preferably protrude downward in FIGS. 5 and 6 beyond the nozzle face 100a in a liquid discharge direction D100 in which the liquid discharge head 100 discharges liquid. The position adjusting arm 42 and the pressing arm 46 that do not protrude beyond the nozzle face 100a in the liquid discharge direction D100 avoid contact with a conveyed object, such as the sheet S, conveyed below the nozzle face 100a precisely and save space in the liquid discharge direction D100. In order to prevent the position adjusting arm 42 and the pressing arm 46 from disturbing the nozzles 4 that discharge liquid, the position adjusting arm 42 and the pressing arm 46 do not overlap the nozzles 4 as illustrated in FIG. 4.

Additionally, according to this embodiment, the first adjusting cam 43 and the second adjusting cam 44 are mounted on an upper face 41b in FIGS. 5 and 6 of the attachment plate 41, which is opposite to a lower face 41c of the attachment plate 41, which mounts the nozzle face 10a. Accordingly, when an operator, such as a user and a service engineer, adjusts the position of the liquid discharge head 100, the operator accesses the first adjusting cam 43 and the second adjusting cam 44 from the upper face 41b of the attachment plate 41, which is opposite to the lower face 41c thereof that mounts the nozzle face 100a. Consequently, the operator adjusts the position of the liquid discharge head 100 readily without touching the nozzle face 100a. Additionally, since the first adjusting cam 43 and the second adjusting cam 44 are mounted on the upper face 41b of the attachment plate 41, which is opposite to the lower face 41c thereof that mounts the nozzle face 100a, the first adjusting cam 43 and the second adjusting cam 44 do not contact the conveyed object such as the sheet S and save space in the liquid discharge direction D100.

Instead of each of the first adjusting cam 43 and the second adjusting cam 44 serving as the arm position adjusting member, a member other than a cam may be employed as the arm position adjusting member.

For example, as illustrated in FIG. 14, a liquid discharge head attachment device 40V includes a first position adjuster 21V and a second position adjuster 22V including eccentric members 51 and 52 serving as arm position adjusting members, respectively. Each of the eccentric members 51 and 52 has a circular outer circumferential face that is eccentric with respect to a center of rotation of each of the eccentric members 51 and 52. As the eccentric members 51 and 52 rotate in rotation directions D51 and D52, respectively, like the first adjusting cam 43 and the second adjusting cam 44, the eccentric members 51 and 52 adjust the position of the liquid discharge head 100 in the nozzle array direction X and the rotation direction θ.

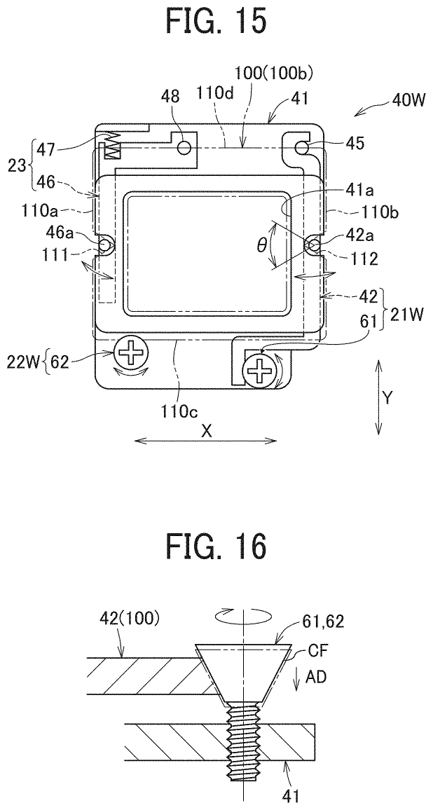

As illustrated in FIGS. 15 and 16, a liquid discharge head attachment device 40W includes a first position adjuster 21W and a second position adjuster 22W including taper screws 61 and 62 serving as arm position adjusting members, respectively. Each of the taper screws 61 and 62 has an outer circumferential face CF that defines a diameter that decreases in an axial direction AD thereof. As illustrated in FIG. 16, as the taper screws 61 and 62 rotate, the tapered, outer circumferential face CF of each of the taper screws 61 and 62 moves upward or downward in the axial direction AD thereof. Hence, the tapered, outer circumferential face CF moves the position adjusting arm 42 or moves the liquid discharge head 100 directly, thus adjusting the position of the liquid discharge head 100 in the nozzle array direction X and the rotation direction θ.

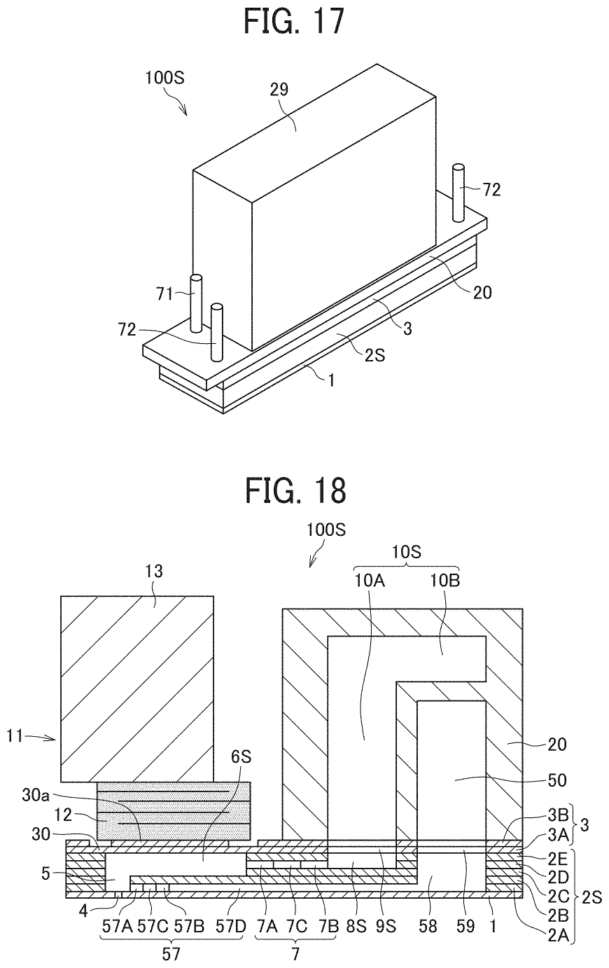

Referring to FIGS. 17 and 18, a description is provided of a construction of a liquid discharge head 100S according to a second embodiment of the present disclosure.

FIG. 17 is an external perspective view of the liquid discharge head 100S. FIG. 18 is a cross-sectional view of the liquid discharge head 100S, taken in a direction perpendicular to a nozzle array direction of the liquid discharge head 100S. FIG. 18 illustrates elements of the liquid discharge head 100S, which correspond to one row of a piezoelectric element.

The liquid discharge head 100S depicted in FIGS. 17 and 18 is a recirculation liquid discharge head. The liquid discharge head 100S includes the nozzle plate 1, a channel substrate 2S, and the vibrating plate member 3 serving as the wall, which are joined into a multilayer. The liquid discharge head 100S further includes the piezoelectric actuator 11, the common channel 20, and a cover 29. The piezoelectric actuator 11 displaces the vibrating portion 30 (e.g., the vibrating plate) of the vibrating plate member 3. The common channel also serves as a frame of the liquid discharge head 100S.

The channel substrate 2S forms a plurality of pressure chambers 6S, the separate supply channel 7, an intermediate supply channel 8S, and the like. The plurality of pressure chambers 6S communicates with the plurality of nozzles 4 through a plurality of nozzle communication channels 5, respectively. The separate supply channel 7 also serves as a plurality of fluid restrictors that communicates with the plurality of pressure chambers 6S, respectively. The intermediate supply channel 8S serves as one or more liquid inlets that communicate with two or more separate supply channels 7.

Like the separate supply channel 7 of the liquid discharge head 100 depicted in FIG. 1, the separate supply channel 7 includes the two channel portions, that is, the first channel portion 7A and the second channel portion 7B, which have fluid resistances greater than a fluid resistance of the pressure chamber 6S. The separate supply channel 7 further includes the third channel portion 7C that is interposed between the first channel portion 7A and the second channel portion 7B and has a fluid resistance smaller than the fluid resistances of the first channel portion 7A and the second channel portion 7B, respectively.

The channel substrate 2S is constructed of a plurality of plates 2A, 2B, 2C, 2D, and 2E, which is layered. Alternatively, the channel substrate 2S may have other construction.

The channel substrate 2S forms a plurality of separate collecting channels 57 and an intermediate collecting channel 58. The plurality of separate collecting channels 57 communicates with the plurality of pressure chambers 6S through the plurality of nozzle communication channels 5, respectively. The plurality of separate collecting channels 57 is disposed in a surface direction of the channel substrate 2S. The intermediate collecting channel 58 serves as one or more liquid outlets that communicate with two or more separate collecting channels 57.

The separate collecting channel 57 includes a first channel portion 57A, a second channel portion 57B, a third channel portion 57C, and a fourth channel portion 57D. Two channel portions, that is, the first channel portion 57A and the second channel portion 57B, have fluid resistances greater than the fluid resistance of the pressure chamber 6S. The third channel portion 57C is interposed between the first channel portion 57A and the second channel portion 57B and has a fluid resistance smaller than the fluid resistances of the first channel portion 57A and the second channel portion 57B, respectively. The fourth channel portion 57D is disposed downstream from the second channel portion 57B in a recirculation direction of liquid and has a channel width identical to a channel width of the third channel portion 57C.

The common channel 20 forms a common supply channel 10S and a common collecting channel 50. According to this embodiment, the common supply channel 10S includes a channel portion 10A that is adjacent to the common collecting channel 50 in the nozzle array direction and a channel portion 10B that is not adjacent to the common collecting channel 50 in the nozzle array direction.

The common supply channel 10S communicates with the intermediate supply channel 8S serving as the liquid inlet through an opening 9S provided in the vibrating plate member 3. The common supply channel 10S communicates with the separate supply channel 7 through the intermediate supply channel 8S. The common collecting channel 50 communicates with the intermediate collecting channel 58 serving as a liquid outlet through an opening 59 provided in the vibrating plate member 3. The common collecting channel 50 communicates with the separate collecting channel 57 through the intermediate collecting channel 58.

As illustrated in FIG. 17, the common supply channel 10S communicates with a supply port 71 and the common collecting channel 50 communicates with a collecting port 72.

Other configurations of the liquid discharge head 100S, that is, a layer configuration of the vibrating plate member 3, a configuration of the piezoelectric actuator 11, and the like, are equivalent to the configurations of the liquid discharge head 100 according to the first embodiment described above.

In the liquid discharge head 100S according to the second embodiment also, like in the liquid discharge head 100 according to the first embodiment depicted in FIG. 1, the piezoelectric element 12 expands in the laminating direction. The piezoelectric element 12 deforms the vibrating portion 30 of the vibrating plate member 3 toward the nozzle 4. The pressure chamber 6S contracts and decreases a volume thereof, pressing liquid inside the pressure chamber 6S and discharging the liquid from the nozzle 4.

Liquid not discharged from the nozzle 4 passes the nozzle 4 and is collected into the common collecting channel 50 from the separate collecting channel 57. The liquid is resupplied from the common collecting channel 50 to the common supply channel 10S through an external recirculating path. Even when the nozzle 4 does not discharge the liquid, the liquid is recirculated from the common supply channel 10S to the common collecting channel 50 through the pressure chamber 6S. The liquid is resupplied to the common supply channel 10S through the external recirculating path.

The liquid discharge head 100S according to the second embodiment also attenuates pressure fluctuation caused by liquid discharging with a simple construction, suppressing transmission of the pressure fluctuation to the common supply channel 10S and the common collecting channel 50.

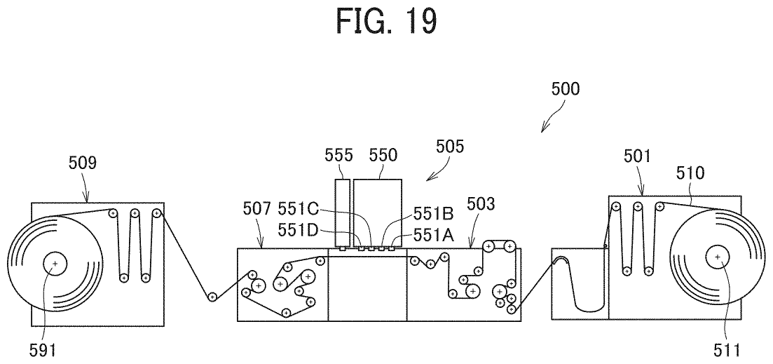

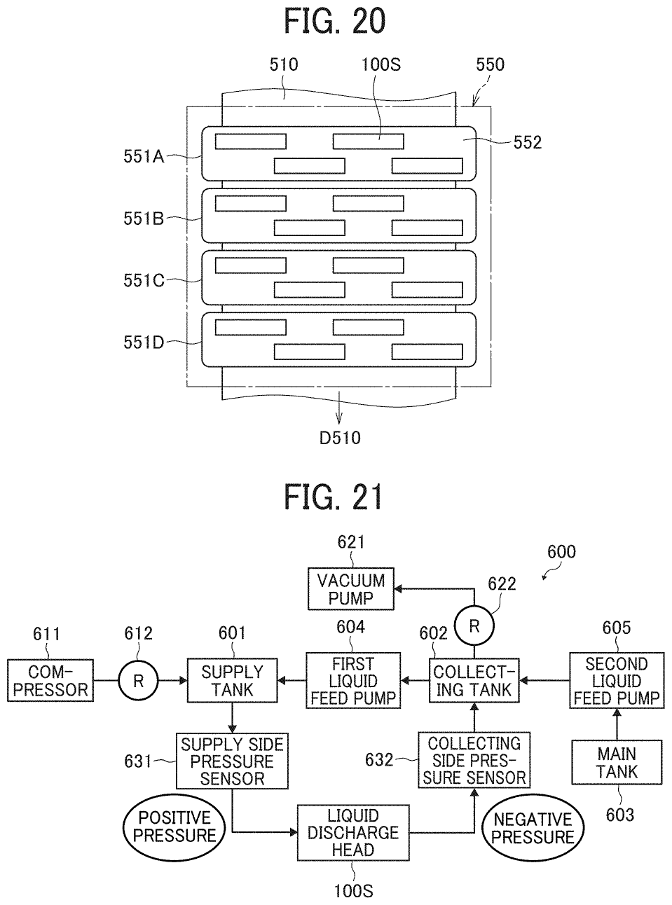

Referring to FIGS. 19 and 20, a description is provided of a construction of a printer 500 serving as a liquid discharge apparatus according to an embodiment of the present disclosure as one example.

FIG. 19 is a schematic cross-sectional view of the printer 500. FIG. 20 is a plan view of a head unit 550 incorporated in the printer 500 as one example.

As illustrated in FIG. 19, the printer 500 serving as the liquid discharge apparatus includes an entry device 501, a guide-conveyor 503, a printing device 505, a dryer 507, and an output device 509. The entry device 501 receives a continuous medium 510. The guide-conveyor 503 guides and conveys the continuous medium 510 such as continuous paper and a sheet conveyed from the entry device 501 to the printing device 505. The printing device 505 performs printing by discharging liquid onto the continuous medium 510 to form an image thereon. The dryer 507 dries the continuous medium 510. The output device 509 outputs the continuous medium 510.

The entry device 501 includes an original winding roller 511 that supplies the continuous medium 510. Each of the entry device 501, the guide-conveyor 503, the dryer 507, and the output device 509 includes rollers that guide and convey the continuous medium 510. The output device 509 includes a reel roller 591 that reels the continuous medium 510.

The continuous medium 510 is conveyed through the printing device 505 such that the continuous medium 510 travels over a conveyance guide while the continuous medium 510 is disposed opposite the head unit 550 and ahead unit 555. The head unit 550 discharges liquid with which the image is formed on the continuous medium 510. The head unit 555 discharges treatment liquid with which the continuous medium 510 bearing the image is treated with post-processing.

As illustrated in FIG. 20, for example, the head unit 550 includes full-line head arrays 551A, 551B, 551C, and 551D corresponding to four colors, respectively, which are arranged in a conveyance direction D510 of the continuous medium 510. The head array 551A is disposed upstream from the head arrays 551B, 551C, and 551D in the conveyance direction D510 of the continuous medium 510.

Each of the head arrays 551A, 551B, 551C, and 551D serves as a liquid discharger. The head arrays 551A, 551B, 551C, and 551D discharge liquid in black (K), cyan (C), magenta (M), and yellow (Y), respectively, onto the continuous medium 510 that is conveyed. Alternatively, the printer 500 may include one or more head arrays that discharge liquid in one or more colors other than black, cyan, magenta, and yellow.

For example, each of the head arrays 551A, 551B, 551C, and 551D is constructed of a base 552 and the liquid discharge heads 100S according to the embodiments of the present disclosure that are arranged on the base 552 in a staggered manner. Alternatively, the head arrays 551A, 551B. 551C, and 551D may be arranged in other manner. Each of the head arrays 551A, 551B, 551C, and 551D may incorporate the liquid discharge heads 100 depicted in FIG. 1.

Referring to FIG. 21, a description is provided of a construction of a liquid recirculating apparatus 600 as one example.

FIG. 21 is a block diagram of the liquid recirculating apparatus 600. FIG. 21 illustrates one liquid discharge head 100S. Alternatively, if the liquid recirculating apparatus 600 includes a plurality of liquid discharge heads 100S that is arranged, each of the liquid discharge heads 100S is coupled with a supply side liquid path disposed on a supply side of the liquid recirculating apparatus 600, which supplies liquid to the liquid discharge head 1005, and is coupled with a collecting side liquid path disposed on a collecting side of the liquid recirculating apparatus 600, which collects the liquid, through a manifold or the like.

The liquid recirculating apparatus 600 includes a supply tank 601, a collecting tank 602, a main tank 603, a first liquid feed pump 604, a second liquid feed pump 605, a compressor 611, a regulator 612, a vacuum pump 621, a regulator 622, a supply side pressure sensor 631, and a collecting side pressure sensor 632.

The compressor 611 and the vacuum pump 621 construct a differential pressure generator that generates differential pressure between pressure inside the supply tank 601 and pressure inside the collecting tank 602.

The supply side pressure sensor 631 is interposed between the supply tank 601 and the liquid discharge head 1005 and coupled with the supply side liquid path coupled with the supply port 71 of the liquid discharge head 100S. The collecting side pressure sensor 632 is interposed between the liquid discharge head 100S and the collecting tank 602 and coupled with the collecting side liquid path coupled with the collecting port 72 of the liquid discharge head 100S.

One end of the collecting tank 602 is connected to the supply tank 601 through the first liquid feed pump 604. Another end of the collecting tank 602 is connected to the main tank 603 through the second liquid feed pump 605.

Accordingly, liquid flows from the supply tank 601 and enters an interior of the liquid discharge head 100S through the supply port 71. The collecting tank 602 collects the liquid from the interior of the liquid discharge head 100S through the collecting port 72. The first liquid feed pump 604 feeds the liquid from the collecting tank 602 to the supply tank 601, thus constructing a recirculating path where the liquid recirculates.

The compressor 611 is connected to the supply tank 601. The supply side pressure sensor 631 is controlled to detect predetermined positive pressure. The vacuum pump 621 is connected to the collecting tank 602. The collecting side pressure sensor 632 is controlled to detect predetermined negative pressure.

Accordingly, while the liquid recirculates through the liquid discharge head 100S, the liquid recirculating apparatus 600 attains constant negative pressure of meniscus.

As the nozzles 4 of the liquid discharge head 100S discharge liquid, an amount of liquid contained in each of the supply tank 601 and the collecting tank 602 decreases. To address this circumstance, the main tank 603 supplies liquid to the collecting tank 602 with the second liquid feed pump 605 properly.

The main tank 603 supplies the liquid to the collecting tank 602 when a liquid height of the liquid contained in the collecting tank 602 is lower than a predetermined height, for example, thus being controlled based on a detection result provided by a surface level sensor or the like installed inside the collecting tank 602.

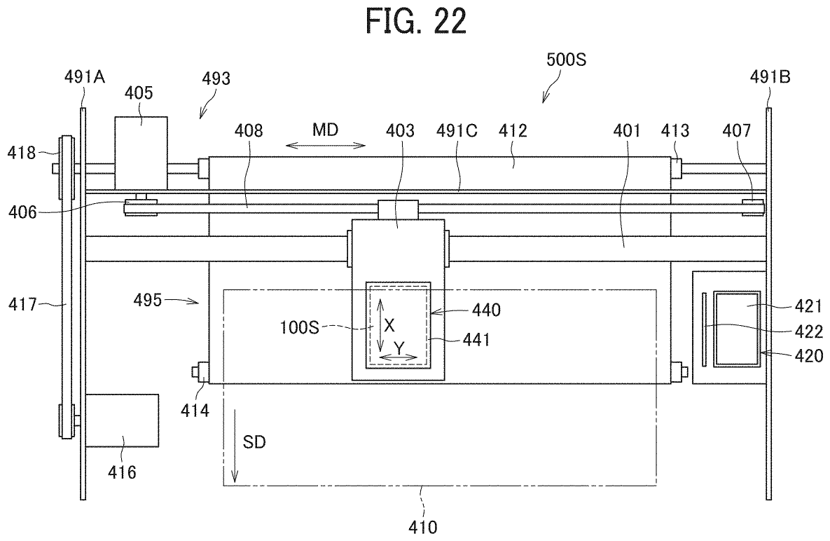

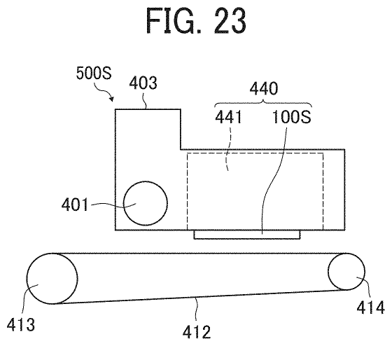

Referring to FIGS. 22 and 23, a description is provided of a construction of a printer 500S serving as a liquid discharge apparatus according to an embodiment of the present disclosure as another example.

FIG. 22 is a plan view of a main section of the printer 500S. FIG. 23 is a side view of the main section of the printer 500S.

The printer 500S is a serial type liquid discharge apparatus. A main scanning direction moving mechanism 493 moves a carriage 403 reciprocally in a main scanning direction MD. The main scanning direction moving mechanism 493 includes a guide 401, a main scanning motor 405, and a timing belt 408. The guide 401 bridges side plates 491A and 491B, that is, a left side plate and a right side plate, respectively, in FIG. 22. The guide 401 movably supports the carriage 403. The main scanning motor 405 moves the carriage 403 reciprocally in the main scanning direction MD through the timing belt 408 looped over a driving pulley 406 and a driven pulley 407.

The carriage 403 mounts a liquid discharge unit 440 into which the liquid discharge head 100S according to the embodiments of the present disclosure and an ink tank 441 are combined. Alternatively, the liquid discharge unit 440 may incorporate the liquid discharge head 100 depicted in FIG. 1. For example, the liquid discharge unit 440 includes the liquid discharge heads 100S that discharge liquid in yellow (Y), cyan (C), magenta (M), and black (K), respectively. The liquid discharge head 100S mounts a plurality of nozzles aligned in a nozzle row in a sub-scanning direction SD perpendicular to the main scanning direction MD. The plurality of nozzles is mounted on the liquid discharge head 100S and oriented downward to discharge liquid downward.

The liquid discharge head 100S is coupled with the liquid recirculating apparatus 600 described above with reference to FIG. 21. The liquid recirculating apparatus 600 recirculates and supplies liquid in a requested color.

The printer 500S includes a conveyance mechanism 495 that conveys a sheet 410. The conveyance mechanism 495 includes a conveyance belt 412 that serves as a conveyor and a sub-scanning motor 416 that drives the conveyance belt 412.

The conveyance belt 412 attracts the sheet 410 and conveys the sheet 410 to an opposed position where the sheet 410 is disposed opposite the liquid discharge head 100S. The conveyance belt 412 is an endless belt looped over a conveyance roller 413 and a tension roller 414. The conveyance belt 412 attracts the sheet 410 by electrostatic attraction, air suction, or the like.

As the sub-scanning motor 416 drives and rotates the conveyance roller 413 through a timing belt 417 and a timing pulley 418, the conveyance belt 412 rotates in the sub-scanning direction SD.

A maintenance-restoration mechanism 420 is disposed opposite one lateral end of each of the carriage 403 and the conveyance belt 412 in the main scanning direction MD. The maintenance-restoration mechanism 420 performs maintenance and restoration of the liquid discharge head 100S.

For example, the maintenance-restoration mechanism 420 includes a cap 421 and a wiper 422. The cap 421 caps a nozzle face (e.g., a face of a nozzle plate) of the liquid discharge head 100S, which mounts the nozzles 4. The wiper 422 wipes the nozzle face of the liquid discharge head 100S.

The main scanning direction moving mechanism 493, the maintenance-restoration mechanism 420, and the conveyance mechanism 495 are attached to a housing constructed of the side plates 491A and 491B, a rear plate 491C, and the like.

With the construction of the printer 500S described above, while the conveyance belt 412 attracts the sheet 410 supplied onto the conveyance belt 412, as the conveyance belt 412 rotates, the conveyance belt 412 conveys the sheet 410 in the sub-scanning direction SD.

While the carriage 403 moves in the main scanning direction MD, as the liquid discharge head 100S is driven according to an image signal, the liquid discharge head 100S discharges liquid onto the sheet 410 that is halted, thus forming an image on the sheet 410. The liquid discharge head 100S according to the embodiments of the present disclosure is oriented such that the nozzle array direction X is perpendicular to a moving direction (e.g., the main scanning direction MD) of the carriage 403. Accordingly, the liquid discharge head 100S eliminates position adjustment in the orthogonal direction Y perpendicular to the nozzle array direction X. For example, a liquid discharge time when the liquid discharge head 100S discharges liquid is adjusted with respect to a moving time when the carriage 403 moves, attaining an advantage equivalent to an advantage attained when the position of the liquid discharge head 100S is adjusted in the orthogonal direction Y perpendicular to the nozzle array direction X. Hence, as the position of the liquid discharge head 100S is adjusted in the nozzle array direction X and the rotation direction θ, shifting of a liquid discharge position onto which the liquid discharge head 100S discharges liquid is eliminated.

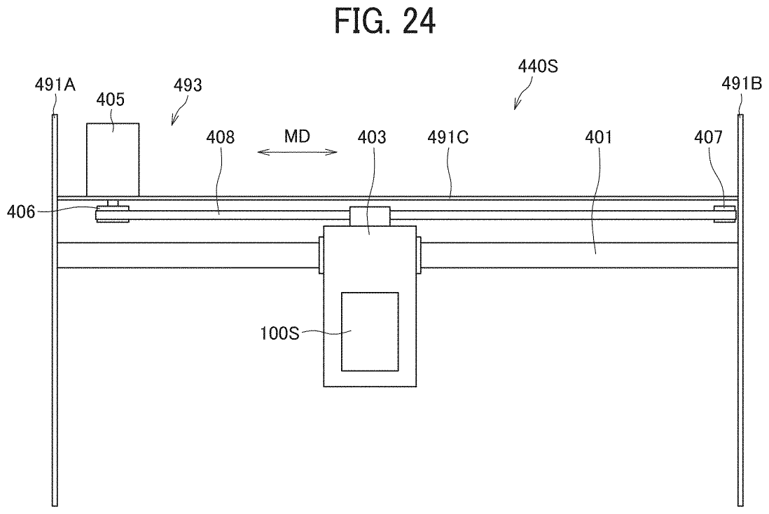

Referring to FIG. 24, a description is provided of a construction of a liquid discharge unit 440S according to an embodiment of the present disclosure as another example.

FIG. 24 is a plan view of a main section of the liquid discharge unit 440S.

The liquid discharge unit 440S includes, among components constructing the printer 500S serving as the liquid discharge apparatus, the housing constructed of the side plates 491A and 491B and the rear plate 491C, the main scanning direction moving mechanism 493, the carriage 403, and the liquid discharge head 100S. Alternatively, the liquid discharge unit 440S may incorporate the liquid discharge head 100 depicted in FIG. 1.

Alternatively, the maintenance-restoration mechanism 420 described above may be attached to the side plate 491B, for example, of the liquid discharge unit 440S.

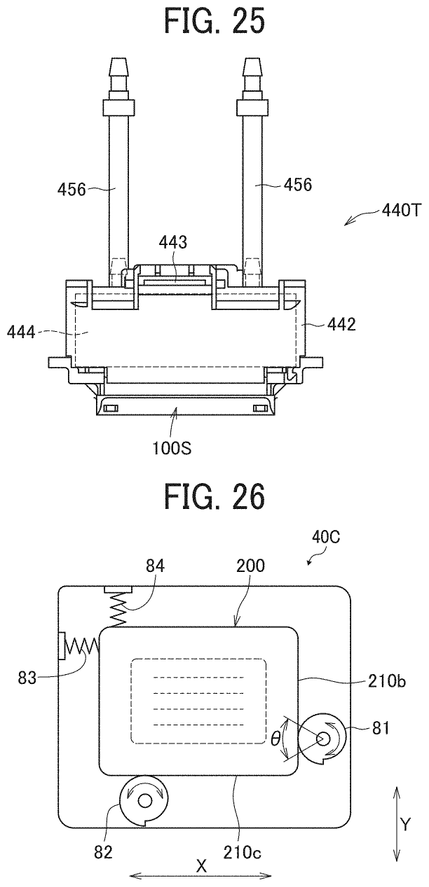

Referring to FIG. 25, a description is provided of a construction of a liquid discharge unit 440T according to an embodiment of the present disclosure as yet another example.

FIG. 25 is a front view of the liquid discharge unit 440T.

The liquid discharge unit 440T includes the liquid discharge head 100S attached with a channel part 444 and tubes 456 coupled with the channel part 444. Alternatively, the liquid discharge unit 440T may incorporate the liquid discharge head 100 depicted in FIG. 1.

The channel part 444 is disposed inside a cover 442. Alternatively, instead of the channel part 444, the liquid discharge unit 440T may incorporate the ink tank 441. A connector 443 is disposed atop the channel part 444 and is electrically connected to the liquid discharge head 100S.

According to the embodiments of the present disclosure, a liquid discharge head is a functional part that discharges or shoots liquid from a nozzle. The discharged liquid is not limited as long as the liquid has viscosity or surface tension that allows discharging from the liquid discharge head. The liquid preferably has a viscosity not greater than 30 mPa s that is obtained by heating and cooling under an ordinary temperature and normal pressure. Specifically, the liquid is solution, suspension, emulsion, or the like that contains a solvent such as water and an organic solvent, a colorant such as a dye and a pigment, a functional material such as a polymerizable compound, resin, and a surfactant, a biocompatible material such as deoxyribonucleic acid (DNA), amino acid, protein, and calcium, an edible material such as a natural color, or the like. For example, the above-described materials are used as inkjet ink, surface treatment liquid, liquid for forming a component of an electronic element or a light emitting element, liquid for forming an electronic circuit resist pattern, a liquid material for three-dimensional fabrication, or the like.

An energy generator that generates energy used for discharging liquid includes a piezoelectric actuator (e.g., a laminated piezoelectric element and a thin film type piezoelectric element), a thermal actuator using a thermoelectric conversion element such as a heat generation resistor, an electrostatic actuator constructed of a vibrating plate and a counter electrode, or the like.

A liquid discharge unit is a unit in which the liquid discharge head is combined with functional parts and a mechanism, that is, an aggregation of parts relating to discharging of liquid. For example, the liquid discharge unit includes a combination of the liquid discharge head with at least one of an ink tank, a carriage, a supply mechanism, a maintenance-restoration mechanism, a main scanning direction moving mechanism, and a liquid recirculating apparatus.

For example, the combination includes a construction in which a first component (e.g., the liquid discharge head) and a second component (e.g., the functional parts and the mechanism) are secured to each other by fastening, adhesion, engagement, or the like, a construction in which the first component movably supports the second component, or a construction in which the second component movably supports the first component. Alternatively, the first component and the second component may be detachably attached to each other.

For example, the liquid discharge unit may include the liquid discharge head that is combined with the ink tank. Alternatively, the liquid discharge unit may include the liquid discharge head that is coupled with the ink tank through a tube or the like and thus combined with the ink tank. A unit including a filter may be added and interposed between the ink tank and the liquid discharge head of the liquid discharge unit.

The liquid discharge unit may include the liquid discharge head that is combined with the carriage.

The liquid discharge unit may include the liquid discharge head that is movably supported by a guide serving as a part of a scanning direction moving mechanism and thus combined with the scanning direction moving mechanism. The liquid discharge unit may include the liquid discharge head that is combined with the carriage and the main scanning direction moving mechanism.

The liquid discharge unit may have a configuration in which a cap serving as a part of the maintenance-restoration mechanism is secured to the carriage mounting the liquid discharge head, thus combining the liquid discharge head with the carriage and the maintenance-restoration mechanism.

The liquid discharge unit may have a configuration in which the tube is coupled with the ink tank or the liquid discharge head mounting a channel part and thus the liquid discharge head is combined with the supply mechanism. Liquid is supplied from a liquid storage to the liquid discharge head through the tube.

The main scanning direction moving mechanism may also include the guide as a single component. The supply mechanism may also include the tube or a loading portion, as a single component.

A liquid discharge apparatus includes the liquid discharge head or the liquid discharge unit. The liquid discharge apparatus drives the liquid discharge head to discharge liquid. The liquid discharge apparatus includes an apparatus that discharges liquid into air or liquid in addition to an apparatus that discharges liquid onto an object to which the liquid adheres.

The liquid discharge apparatus may include means that feeds, conveys, and ejects the object to which the liquid adheres, a pretreatment apparatus, and a post-processing apparatus (e.g., a finisher).

For example, the liquid discharge apparatus is an image forming apparatus or a stereoscopic shaping apparatus. The image forming apparatus discharges ink onto a sheet to form an image on the sheet. The stereoscopic shaping apparatus (e.g., a three-dimensional shaping apparatus) discharges modeling liquid onto a powder layer produced by layering powder to fabricate a stereoscopic object (e.g., a three-dimensional object).

The liquid discharge apparatus is not limited to an apparatus that visualizes a significant image such as a character and a figure with liquid discharged by the apparatus. For example, the liquid discharge apparatus also includes an apparatus that forms a pattern and the like that do not have meaning and an apparatus that fabricates a three-dimensional statue.

The object to which the liquid adheres denotes an object to which liquid adheres at least temporarily. For example, the liquid is adhered and fixed to the object or is adhered to and permeated into the object. Specifically, the object to which the liquid adheres includes recording media such as a sheet, recording paper, a recording sheet, film, and cloth, electronic components such as an electronic substrate and a piezoelectric element, and media such as a powder layer, an organ model, and an inspection cell. The object to which the liquid adheres includes any object to which liquid adheres unless otherwise specified.

The object to which the liquid adheres is made of a material to which the liquid adheres at least temporarily, for example, paper, thread, fiber, cloth, leather, metal, plastic, glass, wood, and ceramics.

The liquid discharge apparatus is an apparatus in which the liquid discharge head and the object to which the liquid adheres move relative to each other. However, the liquid discharge apparatus may have other configurations. For example, the liquid discharge apparatus may be a serial type apparatus in which the liquid discharge head moves, a line type apparatus in which the liquid discharge head does not move, or the like.

Further, the liquid discharge apparatus may be a treatment liquid applicating apparatus that discharges treatment liquid onto a sheet to apply the treatment liquid onto a surface of the sheet to achieve an objective such as reforming the surface of the sheet, a jet granulator that jets composition liquid prepared by dispersing a raw material in a solution through a nozzle to granulate fine particles of the raw material, or the like.

The terms used in the present disclosure, that is, image formation, recording, printing, imaging, modeling, fabricating, and the like, are synonyms.

A description is provided of advantages of a liquid discharge head attachment device (e.g., the liquid discharge head attachment devices 40, 40S, 40T, 40V, and 40W).

The liquid discharge head attachment device is attached with a liquid discharge head (e.g., the liquid discharge heads 100 and 100S) including a plurality of nozzles (e.g., the nozzles 4) that discharges liquid. The liquid discharge head attachment device includes an attachment member (e.g., the attachment plate 41) and a position adjuster (e.g., the position adjusting arm 42). The attachment member is attached with the liquid discharge head. The liquid discharge head includes a nozzle face (e.g., the nozzle face 100a) that mounts the nozzles and a side face (e.g., the side face 110b) that is perpendicular to the nozzle face. The position adjuster contacts the side face of the liquid discharge head and adjusts a position of the liquid discharge head with respect to the attachment member. The position adjuster is disposed outboard from the nozzles of the liquid discharge head. At least a part of the position adjuster overlaps the liquid discharge head in an orthogonal direction perpendicular to the nozzle face of the liquid discharge head. In other words, at least a part of the position adjuster overlaps a portion of the liquid discharge head, which is other than the nozzles, in the orthogonal direction.

Accordingly, the liquid discharge head attachment device saves space.

The above-described embodiments are illustrative and do not limit the present disclosure. Thus, numerous additional modifications and variations are possible in light of the above teachings. For example, elements and features of different illustrative embodiments may be combined with each other and substituted for each other within the scope of the present disclosure.

Any one of the above-described operations may be performed in various other ways, for example, in an order different from the one described above.

What is claimed is:

1. A liquid discharge head attachment device comprising:
a liquid discharge head including a plurality of nozzles configured to discharge liquid, the liquid discharge head having a nozzle face mounting the nozzles and a side face being perpendicular to the nozzle face;
an attachment member attached with the liquid discharge head; and
a position adjuster configured to contact the side face of the liquid discharge head and adjust a position of the liquid discharge head with respect to the attachment member,
the position adjuster disposed outboard from the nozzles of the liquid discharge head, the position adjuster configured to overlap the liquid discharge head in an orthogonal direction perpendicular to the nozzle face of the liquid discharge head in at least a part of the position adjuster.

2. The liquid discharge head attachment device according to claim 1, further comprising a support shaft,
wherein the position adjuster includes a position adjusting arm configured to pivot about the support shaft.

3. The liquid discharge head attachment device according to claim 2,
wherein the liquid discharge head further has another side face being perpendicular to the nozzle face, and
wherein the position adjusting arm is configured to protrude beyond said another side face of the liquid discharge head with a protruding amount not greater than 1 mm.

4. The liquid discharge head attachment device according to claim 2,
wherein the position adjuster further includes an arm position adjusting member configured to contact the position adjusting arm and change a position of the position adjusting arm in a pivot direction of the position adjusting arm.

5. The liquid discharge head attachment device according to claim 4,
wherein the position adjusting arm includes a contact portion configured to contact the side face of the liquid discharge head,
wherein the arm position adjusting member includes a contact portion configured to contact the position adjusting arm, and
wherein the contact portion of the position adjusting arm is closer to the support shaft than the contact portion of the arm position adjusting member is.

6. The liquid discharge head attachment device according to claim 5,
wherein the arm position adjusting member further includes a cam configured to rotate, the cam having a radius from a center of rotation to an outer circumferential face of the cam, the radius configured to change in a rotation direction of the cam.

7. The liquid discharge head attachment device according to claim 5,
wherein the arm position adjusting member further includes an eccentric member configured to rotate, the eccentric member having a radius from a center of rotation to an outer circumferential face of the eccentric member, the radius configured to change in a rotation direction of the eccentric member.

8. The liquid discharge head attachment device according to claim 5,
wherein the arm position adjusting member further includes a taper screw having an outer circumferential face defining a diameter that decreases in an axial direction of the taper screw.

9. The liquid discharge head attachment device according to claim 5,
wherein the liquid discharge head further has another side face extending in a nozzle array direction in which the plurality of nozzles is arranged linearly, and
wherein the arm position adjusting member is disposed opposite said another side face of the liquid discharge head.

10. The liquid discharge head attachment device according to claim 5,
wherein the liquid discharge head further has another side face being perpendicular to a nozzle array direction in which the plurality of nozzles is arranged linearly, and
wherein the arm position adjusting member is disposed opposite said another side face of the liquid discharge head.

11. The liquid discharge head attachment device according to claim 5,
wherein the attachment member has a first face mounting the arm position adjusting member and a second face mounting the nozzle face of the liquid discharge head and being opposite to the first face.

12. The liquid discharge head attachment device according to claim 2,
wherein the liquid discharge head further includes a recess disposed on the side face, and
wherein the position adjusting arm includes a projection configured to contact the recess.

13. The liquid discharge head attachment device according to claim 2,
wherein the position adjusting arm is configured not to protrude beyond the nozzle face of the liquid discharge head in a liquid discharge direction in which the liquid discharge head discharges liquid.

14. The liquid discharge head attachment device according to claim 1, further comprising:
another liquid discharge head;
another attachment member attached with said another liquid discharge head; and
another position adjuster configured to contact said another liquid discharge head and adjust a position of said another liquid discharge head with respect to said another attachment member.

15. The liquid discharge head attachment device according to claim 1,
wherein the position adjuster includes:
a first position adjusting member configured to adjust the position of the liquid discharge head in a predetermined direction; and
a second position adjusting member configured to adjust the position of the liquid discharge head in a direction different from the predetermined direction.

16. The liquid discharge head attachment device according to claim 15,
wherein the second position adjusting member is configured to contact the liquid discharge head directly to adjust the position of the liquid discharge head.

17. The liquid discharge head attachment device according to claim 15,
wherein the liquid discharge head further includes a slope inclined with respect to a nozzle array direction in which the plurality of nozzles is arranged linearly.

18. The liquid discharge head attachment device according to claim 17, further comprising a presser configured to contact the slope and press the liquid discharge head against the first position adjusting member and the second position adjusting member.

19. A liquid discharge unit comprising:
a liquid discharge head including a plurality of nozzles configured to discharge liquid, the liquid discharge head having a nozzle face mounting the nozzles and a side face being perpendicular to the nozzle face;
an attachment member attached with the liquid discharge head; and
a position adjuster configured to contact the side face of the liquid discharge head and adjust a position of the liquid discharge head with respect to the attachment member,
the position adjuster disposed outboard from the nozzles of the liquid discharge head, the position adjuster configured to overlap the liquid discharge head in an orthogonal direction perpendicular to the nozzle face of the liquid discharge head in at least a part of the position adjuster.

20. A liquid discharge apparatus comprising:
a carriage; and
a liquid discharge unit mounted on the carriage,
the liquid discharge unit including:
a liquid discharge head including a plurality of nozzles configured to discharge liquid, the liquid discharge head having a nozzle face mounting the nozzles and a side face being perpendicular to the nozzle face;
an attachment member attached with the liquid discharge head; and
a position adjuster configured to contact the side face of the liquid discharge head and adjust a position of the liquid discharge head with respect to the attachment member,
the position adjuster disposed outboard from the nozzles of the liquid discharge head, the position adjuster configured to overlap the liquid discharge head in an orthogonal direction perpendicular to the nozzle face of the liquid discharge head in at least a part of the position adjuster.
